(19) United States
(12) Patent Application Publication
(10) Pub. No.: US 2011/0218948 A1
(43) Pub. Date: Sep. 8, 2011

(54) METHODS FOR DETECTING SPAMMERS AND CONTENT PROMOTERS IN ONLINE VIDEO SOCIAL NETWORKS

(76) Inventors: Fabricio Benevenuto De Souza, Bello Horizonte (BR); Tiago Rodrigues De Magalhaes, Bello Horizonte (BR); Virgilio Augusto Femandes Almeida, Bello Horizonte (BR); Jussara Marques De Almeida, Bello Horizonte (BR); Marcos Andre Goncalves, Bello Horizonte (BR)

(21) Appl. No.: 12/967,923

(22) Filed: Dec. 14, 2010

Related U.S. Application Data
(60) Provisional application No. 61/286,548, filed on Dec. 15, 2009.

(51) Int. Cl. G06F 15/18; G06N 5/02; G06F 15/16

(52) U.S. Cl. 706/12

(57) ABSTRACT

The present invention relates to a method for detecting video spammers and promoters in online video social systems. Using attributes based on the user's profile, the user's social behavior in the system, and the videos posted by the user as well as the target (responded) videos, the feasibility of applying a supervised learning method to identify polluters (spammers and promoters) is investigated.

This application claims the priority of U.S. Patent Application No. 61/286,548, filed Dec. 15, 2009, which is incorporated herein by reference in its entirety.

### BACKGROUND OF THE INVENTION

The present invention relates to a method for detecting video spammers and promoters in online video social systems. Using attributes based on the users profile, the user's social behavior in the system, and the videos posted by the user as well as the target (responded) videos, the feasibility of applying a supervised learning method to identify polluters (spammers and promoters) is investigated.

Content pollution has been observed in various applications, including email (as described by L. Gomes, J. Almeida, V. Almeida, and W. Meira in Workload models of spamand legitimate e-mails. Performance Evaluation), Web search engines (as described by D. Fetterly, M. Manasse, and M. Najork in Spam, damn spam, and statistics: Using statistical analysis to locate spam web pages), blogs (as described by A. Thomason in Blog spam: A review). Therefore, a number of detection and combating strategies have been proposed (for example, documents C. Castillo, D. Donato, A. Gionis, V. Murdock, and F. Silvestri in Know your neighbors: Web spam detection using the web topology, Z. Gyöngyi, H. Garcia-Molina, and J. Pedersen in Combating web spam with trustrank, Y. Lin, H. Sundaram, Y. Chi, J. Tatemura, and B. Tseng in Detecting splogs via temporal dynamics using self-similarity analysis, Y. Xie, F. Yu, K. Achan, R. Panigrahy, G. Hulten, and I. Osipkov in Spamming botnets: Signatures and characteristics). Most of them rely on extracting evidences from textual descriptions of the content, treating the text corpus as a set of objects with associated attributes, and applying some classification method to detect spam as described by P. Heymann, G. Koutrika, and H. Garcia-Molina in Fighting spam on social web sites: A survey of approaches and future challenges. A framework to detect spamming in tagging systems, a malicious behavior that aims at increasing the visibility of an object by fooling the search mechanism, was proposed by G. Koutrika, F. Effendi, Z. Gyöngyi, P. Heymann, and H. Garcia-Molina in Combating spam in tagging systems. A few other strategies rely on image processing algorithms to detect spam in image-based e-mails, as proposed by C. Wu, K. Cheng, Q. Zhu, and Y. Wu in Using visual features for anti-spam filtering.

The present invention aims at detecting users who disseminate video pollution, instead of classifying the content itself. Content-based classification would require combining multiple forms evidences extracted from textual descriptions of the video (for example, tags, title) and from the video content itself, which, in turn, would require more sophisticated multimedia information retrieval methods that are robust to the typically low quality of user-generated videos as described by S. Boll in Multitube—where web 2.0 and multimedia could meet. Instead, it is explored attributes that capture the feedback of users with respect to each other or to their contributions to the system (for example, number of views received), exploiting their interactions through video responses.

The present invention is also based on other studies of the properties of social networks such as Y. Ahn, S. Han, H. Kwak, S. Moon, and H. Jeong in Analysis of topological characteristics of huge online social networking services, A. Mislove, M. Marcon, K. Gummadi, P. Druschel, and B. Bhattacharjee in Measurement and analysis of online social networks) and of the traffic to online social networking systems, in particular YouTube. An in-depth analysis of popularity distribution and evolution, and content characteristics of YouTube and of a popular Korean service is presented by M. Cha, H. Kwak, P. Rodriguez, Y. Ahn, and S. Moon in I tube, you tube, everybody tubes: Analyzing the world's largest user generated content video system. Gill et al, in Youtube traffic characterization: A view from the edge characterize YouTube traffic collected from a university campus network, comparing its properties with those previously reported for other workloads.

### OBJECTIVES OF THE INVENTION

A first objective of the invention is to provide a method for detecting users who disseminate video pollution in online video sharing systems exploring attributes that capture the feedback of users with respect to each other or to their contributions to the system (for example, number of views received), exploiting their interactions through video responses.

### BRIEF DESCRIPTION OF THE INVENTION

With Internet video sharing sites gaining popularity at a dazzling speed, the Web is being transformed into a major channel for the delivery of multimedia. Online video social networks, out of which YouTube is the most popular, are distributing videos at a massive scale. As an example, according to comScore, in May 2008, 74 percent of the total U.S. Internet audience viewed online videos, being responsible for 12 billion videos viewed on that month (YouTube alone provided 34% of these videos). Additionally, with ten hours of videos uploaded every minute, YouTube is also considered the second most searched site in the Web.

By allowing users to publicize and share their independently generated content, online video social networks may become susceptible to different types of malicious and opportunistic user actions. Particularly, these systems usually offer three basic mechanisms for video retrieval: (1) a search system, (2) ranked lists of top videos, and (3) social links between users and/or videos. Although appealing as mechanisms to ease content location and enrich online interaction, these mechanisms open opportunities for users to introduce polluted content, or simply pollution, into the system. As an example, video search systems can be fooled by malicious attacks in which users post their videos with several popular tags, as described by G. Koutrika, F. Effendi, Z. Gyöngyi, P. Heymann, and H. Garcia-Molina in Combating spam in tagging systems. Opportunistic behavior on the other two mechanisms for video retrieval can be exemplified by observing a YouTube feature which allows users to post a video as a response to a video topic. Some users, which we call spammers, may post an unrelated video as response to a popular video topic aiming at increasing the likelihood of the response being viewed by a larger number of users. Additionally, users we refer to as promoters may try to gain visibility to a specific video by posting a large number of (potentially unrelated) responses to boost the rank of the video topic, making it appear in the top lists maintained by YouTube. Promoters and spammers are driven by several goals, such as to spread advertise to generate sales, disseminate pornography (often as an advertisement to a Web site), or just to compromise system reputation.

Polluted content may compromise user patience and satisfaction with the system since users cannot easily identify the pollution before watching at least a segment of it, which also consumes system resources, especially bandwidth. Additionally, promoters can further negatively impact system aspects, since promoted videos that quickly reach high rankings are strong candidates to be kept in caches or in content distribution networks (as described by M. Cha, H. Kwak, P. Rodriguez, Y. Ahn, and S. Moon. on I tube, you tube, everybody tubes: Analyzing the world's largest user generated content video system; In Internet Measurement Conference (IMC), 2007).

The present invention, addresses the issue of detecting video spammers and promoters. To do it, it is crawled a large user data set from YouTube site, containing more than 260 thousands users. Then, a labeled collection with users “manually” classified as legitimate, spammers and promoters was created. After that, it is conducted a study about the collected user behavior attributes aiming at understanding their relative discriminative power in distinguishing between legitimate users and the two different types of polluters envisioned. Using attributes based on the user's profile, the user's social behavior in the system, and the videos posted by the user as well as his target (responded) videos, it is investigated the feasibility of applying a supervised learning method to identify polluters. It is found that this approach is able to correctly identify the majority of the promoters, misclassifying only a small percentage of legitimate users. In contrast, although this approach is able to detect a significant fraction of spammers, they showed to be much harder to distinguish from legitimate users. These results motivated the investigation of a hierarchical classification approach, which explores different classification tradeoffs and provides more flexibility for the application of different actions to the detected polluters.

### BRIEF DESCRIPTION OF THE DRAWINGS

FIG. 1 is the Algorithm 1 which obtains a representative sample of a video response user graph;

FIG. 2 is a set of graphics demonstrating the cumulative distribution of user behavior attributes for spammers, promoters and legitimate users;

FIG. 3 is the fluxogram representation illustrating two classification strategies: flat (left) and hierarchical (right);

FIG. 4 is the graphical representation demonstrating the impact of varying the J parameter comparing spammers vs. legitimate users (a) and heavy vs. light promoters (b); and

FIG. 5 the graphical representation illustrating of the impact of reducing the set of attributes for two different scenarios.

### DETAILED DESCRIPTION OF THE INVENTION

In order to evaluate the proposed approach to detect video spammers and promoters in online video social networking systems, it is necessary a test collection of users, pre-classified into the target categories, namely, spammers, promoters and, in lack of a better term, legitimate users. However, no such collection is publicly available for any video sharing system, thus requiring the building of one.

Before presenting the steps taken to build the user test collection, it is introduced some notations and definitions. It is noticed that an online video is a responded video or a video topic if it has at least one video response. Similarly, we say a user is a responsive user if he has posted at least one video response, whereas a responded user is someone who posted at least one responded video. Moreover, the spammer is a user who posts at least one video response that is considered unrelated to the responded video (i.e., a spam). Examples of video spams are: (i) an advertisement of a product or website completely unrelated to the subject of the responded video, and (ii) pornographic content posted as response to a cartoon video. A promoter is defined as a user who posts a large number of video responses to a responded video, aiming at promoting this video topic. As an example, it is found promoters in the dataset who posted a long sequence (for example, 100) of (unrelated) video responses, often without content (0 second) to a single video. A user that is neither a spammer nor a promoter is considered legitimate. The term polluter is used to refer to either a spammer or a promoter.

The user test collection was created by first crawling YouTube, one of the most popular social video sharing systems. Next, a subset of these users was carefully select and manually classified.

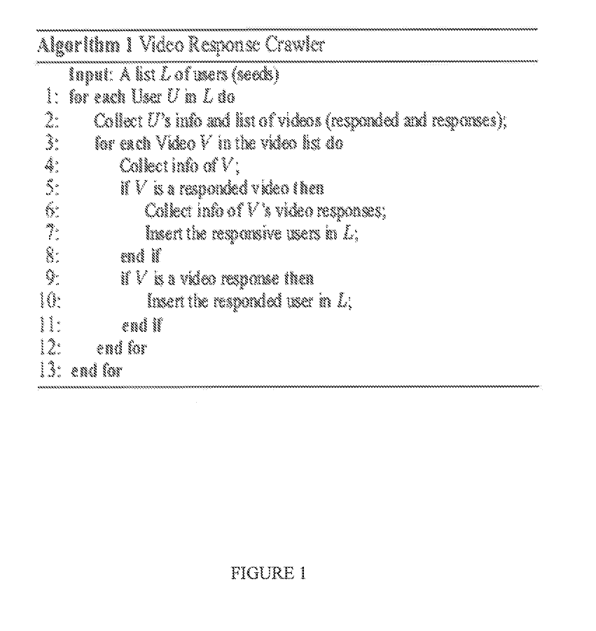

The strategy consists of collecting a sample of users who participate in interactions through video responses, i.e., who post or receive video responses. These interactions can be represented by a video response user graph G=(X, Y), where X is the union of all users who posted or received video responses until a certain instant of time, and (x₁, x₂) is a directed arc in Y if user x₁εX has responded to a video contributed by user x₂εX. In order to obtain a representative sample of the YouTube video response user graph, we build a crawler that implements an Algorithm 1 as shown in FIG. 1. The sampling starts from a set of 88 seeds, consisting of the owners of the top-100 most responded videos of all time, provided by YouTube. The crawler follows links of responded videos and video responses, gathering information on a number of different attributes of their contributors (users), including attributes of all responded videos and video responses posted by him.

The crawler ran for one week (Jan. 11-18, 2008), gathering a total of 264,460 users, 381,616 responded videos and 701,950 video responses. This dataset produces a large weakly connected component of graph (X, Y), and is used as source for building the test collection, as described below.

The main goal of creating a user test collection is to study the patterns and characteristics of each class of users. Thus, the desired properties for the test collection include the following: (1) having a significant number of users of all three categories; (2) including, but not restricting to, spammers and promoters which are aggressive in their strategies and generate large amounts of pollution in the system; and (3) including a large number of legitimate users with different behavioral profiles. These properties may not be achieved by simply randomly sampling the collection. The reasons for this are twofold. First, randomly selecting a number of users from the crawled data could lead us to a small number of spammers and promoters, compromising the creation of effective training and test data sets for the analysis. Moreover, research has shown that the sample does not need to follow the class distribution in the collection in order to achieve effective classification (as described by G. Weiss and F. Provost in The effect of class distribution on classifier learning: An empirical study; technical report, 2001). Second, it is natural to expect that legitimate users present a large number of different behaviors in a social network. Thus, selecting legitimate users randomly may lead to a large number of users with similar behavior (i.e. post one video response to a discussed topic), not including examples with different profiles.

Aiming at capturing all these properties, it is defined three strategies for user selection (described below). Each selected user was then manually classified. However, this classification relies on human judgment on, for instance, whether a video is related to another. In order to minimize the impact of human error, three volunteers analyzed all video responses of each selected user in order to independently classify the same into one of the three categories. In case of tie (i.e., each volunteer chooses a different class), a fourth independent volunteer was heard. Each user was classified based on majority voting. Volunteers were instructed to favor legitimate users. For instance, if one was not confident that a video response was unrelated to the responded video, he should consider it to be legitimate. Moreover, video responses containing people chatting or expressing their opinions were classified as legitimate, as we choose not to evaluate the expressed opinions. The volunteers agreed in about 97% of the analyzed videos, which reflects a high level of confidence to this human classification process. The three user selection strategies used are:

(1) In order to select users with different levels of interaction through video responses, firstly it is defined four groups of users based on their in and out-degrees in the video response user graph. Group 1 consists of users with low (≦10) in and out-degrees, and thus who respond to and are responded by only a few other users. Group 2 consists of users with high (>10) in-degree and low out-degree, and thus receive video responses from many others but post responses to only a few users. Group 3 consists of users with low in-degree and high out-degree, whereas very interactive users, with high in and out-degrees, fall into group 4. One hundred users were randomly selected from each group and manually classified, yielding a total of 382 legitimate, 10 spammers, and no promoter. The remaining 8 users were discarded as they had their accounts suspended due to violation of terms of use.
(2) Aiming at populating the test collection with polluters, they were searched where they are more likely to be found. It is noticed that, in YouTube, a video v can be posted as response to at most one video at a time (unless one creates a copy of v and uploads it with a different ID). Thus, it is more costly for spammers to spread their video spam in YouTube than it is, for instance, to disseminate spam by e-mail. Therefore, it is verified that spammers would post their video responses more often to popular videos so as to make each spam visible to a larger community of users. Moreover, some video promoters might eventually be successful and have their target listed among the most popular videos. Thus, the video responses posted to the top 100 most responded videos of all time were browsed, selecting a number of suspect users. The classification of these suspect users led to 7 legitimate users, 118 spammers, and 28 promoters in the test collection.
(3) To minimize a possible bias introduced by strategy (2), 300 users who posted video responses to the top 100 most responded videos of all time were randomly selected, finding 252 new legitimate users, 29 new spammers and 3 new promoters (16 users with closed accounts were discarded).

In total, the test collection contains 829 users, including 641 classified as legitimate, 157 as spammers and 31 as promoters. Those users posted 20,644 video responses to 9,796 unique responded videos. The user test collection aims at supporting research on detecting spammers and promoters.

Legitimate users, spammers and promoters have different goals in the system, and, thus, it is expected that they also differ on how they behave (for example, who they interact with, which videos they post) to achieve their purposes. Thus, the next step is to analyze a large set of attributes that reflect user behavior in the system aiming at investigating their relative discriminatory power to distinguish one user class from the others. Three attribute sets were considered, namely, video attributes, user attributes, and social network (SN) attributes.

Video attributes capture specific properties of the videos uploaded by the user, i.e., each user has a set of videos in the system, each one with attributes that may serve as indicators of its “quality”, as perceived by others. In particular, each video was characterized by its duration, numbers of views and of commentaries received, ratings, number of times the video was selected as favorite, as well as numbers of honors and of external links. Moreover, three separate groups of videos owned by the user were considered. The first group contains aggregate information of all videos uploaded by the user, being useful to capture how others see the (video) contributions of this user. The second group considers only video responses, which may be pollution. The last group considers only the responded videos to which this user posted video responses (referred to as target videos). For each video group, it is considered the average and the sum of the aforementioned attributes, summing up 42 video attributes for each user, all of which can be easily derived from data maintained by YouTube. It is explicitly that it is chosen not to add any attribute that would require processing the multimedia content itself.

The second set of attributes consists of individual characteristics of user behavior. It is expected that legitimate users spend more time doing actions such as selecting friends, adding videos as favorites, and subscribing to content updates from others. Thus, the following 10 user attributes were selected: number of friends, number of videos uploaded, number of videos watched, number of videos added as favorite, numbers of video responses posted and received, numbers of subscriptions and subscribers, average time between video uploads, and maximum number of videos uploaded in 24 hours.

The third set of attributes captures the social relationships established between users via video response interactions, which is one of the several possible social networks in YouTube. The idea is that these attributes might capture specific interaction patterns that could help differentiate legitimate users, promoters, and spammers. The following node attributes extracted from the video response user graph, which capture the level of (social) interaction of the corresponding user, were selected: clustering coefficient, betweenness, reciprocity, assortativity, and UserRank.

The clustering coefficient of node i, cc(i), is the ratio of the number of existing edges between i's neighbors to the maximum possible number, and captures the communication density between the user's neighbors. The betweenness is a measure of the node's centrality in the graph, that is, nodes appearing in a larger number of the shortest paths between any two nodes have higher betweenness than others (as described by M. Newman and J. Park in Why social networks are different from other types of networks. Phys. Rev. E, 68, 2003). The reciprocity R(i) of node i measures the probability of the corresponding user uᵢ receiving a video response from each other user to whom he posted a video response, that is:

$$R ( i ) = \frac{\vert OS ( i ) ⋂ \vert S ( i ) \vert}{\vert OS ( i )} \qquad Equation ( 1 )$$

where OS(i) is the set of users to who uᵢ posted a video response, and IS(i) is the set of users who posted video responses to uᵢ. Node assortativity is defined by C. Castillo, D. Donato, A. Gionis, V. Murdock, and F. Silvestri in Know your neighbors: Web spam detection using the web topology, as the ratio between the node (in/out) degree and the average (in/out) degree of its neighbors. The node assortativity were computed for the four types of degree-degree correlations (i.e., in-in, in-out, out-in, out-out). Finally, the PageRank (as described by S. Brin and L. Page in The anatomy of a large-scale hypertextual web search engine; In Int'l World Wide Web Conference (WWW), 1998) algorithm was also applied, commonly used to assess the popularity of a Web page (as described by A. Langville and C. Meyer in Google's PageRank and Beyond: The Science of Search Engine Rankings, Princeton University Press, 2006), to the video response user graph (as described by A. Langville and C. Meyer in Google's PageRank and Beyond: The Science of Search Engine Rankings; Princeton University Press, 2006). The computed metric, which we refer to as UserRank, indicates the degree of participation of a user in the system through interactions via video responses. In total, we selected 8 social network attributes.

The relative power of the 60 selected attributes were assessed in discriminating one user class from the others by independently applying two well known feature selection methods, namely, information gain and X² (Chi Squared) (as described by Y. Yang and J. Pedersen in A comparative study on feature selection in text categorization, In Int'l Conference on Machine Learning (ICML), 1997). Table 1 summarizes the results, showing the number of attributes from each set (video, user, and social network) in the top 10, 20, 30, 40, and 50 most discriminative attributes according to the ranking produced by X². Results for information gain are very similar and, thus, are omitted.

TABLE 1
Number of Attributes at Top Positions in X² Ranking

| Attribute Set | Top 10 | Top 20 | Top 30 | Top 40 | Top 50 |
|---|---|---|---|---|---|
| Video | 9 | 18 | 25 | 30 | 36 |
| User | 1 | 2 | 4 | 7 | 9 |
| SN | 0 | 0 | 1 | 3 | 5 |

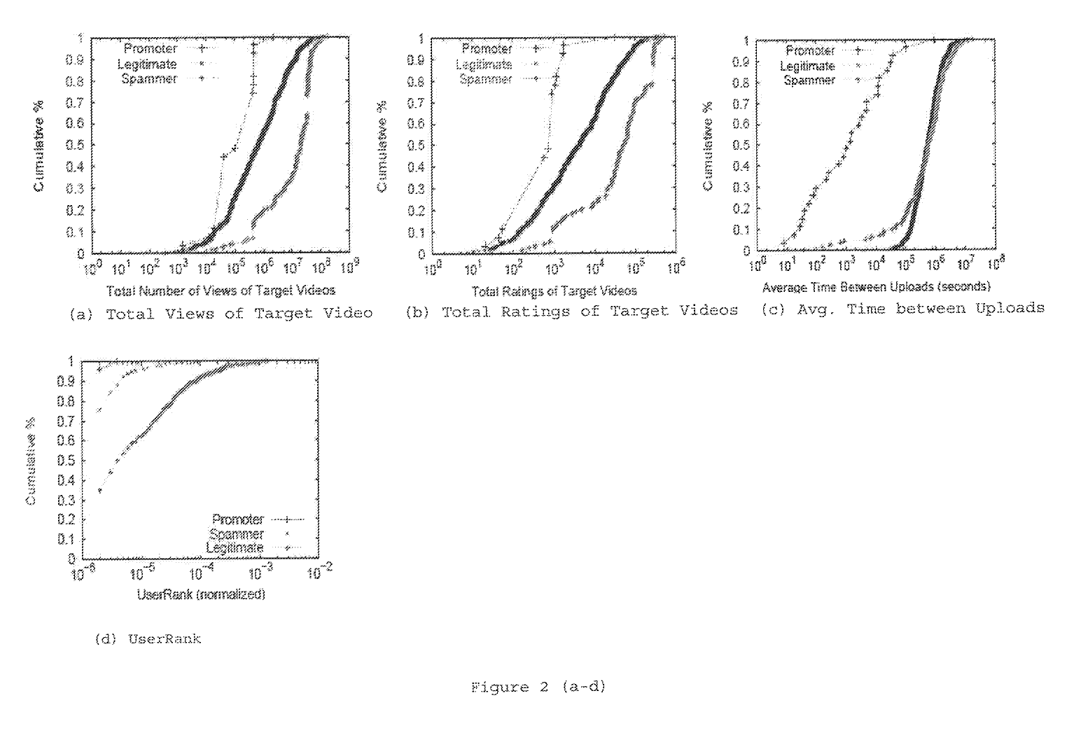

Note that the 9 of the 10 most discriminative attributes are videorelated. In fact, the most discriminative attribute (according to both methods), is the total number of views (i.e., the popularity) of the target videos. FIG. 2(a) presents the cumulative distributions of this metric for each user class, showing a clear distinction among them. The curve for spammers is much more skewed towards a larger number of views, since these users tend to target popular videos in order to attract more visibility to their content. In contrast, the curve for promoters is more skewed towards the other end as they tend to target videos that are still not very popular, aiming at raising their visibility. Legitimate users, being driven mostly by social relationships and interests, exhibit an intermediary behavior, targeting videos with a wide range of popularity. The same distinction can be noticed for the distributions of the total ratings of target videos, shown in FIG. 2(b), another metric that captures user feedback with respect to these videos, and is among the top 10 most discriminative attributes.

The most discriminative user and social network attributes are the average time between video uploads and the UserRank, respectively. In fact, FIG. 2(c) and (d) show that, in spite of appearing in lower positions in the ranking, particularly for the UserRank attribute (see Table 1), these two attributes have potential to be able to separate user classes apart. In particular, the distribution of the average time between video uploads clearly distinguishes promoters, who tend to upload at a much higher frequency since their success depends on them posting as many video responses to the target as possible. FIG. 2(c) also shows that, at least with respect to this user attribute, spammers cannot be clearly distinguished from legitimate users. Finally, FIG. 2(d) shows that legitimate users tend to have much higher UserRank values than spammers, who, in turn, have higher UserRank values than promoters. This indicates that, as expected, legitimate users tend to have a much more participative role (system-wide) in the video response interactions than users from the other two classes, which are much more selective when choosing their targets.

### Detecting Spammers and Promoters

The investigation of the feasibility of applying a supervised learning algorithm along with the attributes discussed previously for the task of detecting spammers and promoters is done by representing each user by a vector of values, one for each attribute. For example, it is considered 60 different attributes listed below. Attributes 1 to 42 are related to properties of the videos uploaded by each user (Total number of views of all video responses; Total number of views of all responded videos; Total duration of all videos uploaded; Total duration of all video responses; Total duration of all responded videos; Total number of ratings of all videos uploaded; Total number of ratings of all video responses; Total number of ratings of all responded videos; Total number of comments of all videos uploaded; Total number of comments of all video responses; Total number of comments of all responded videos; Total number of times that all videos uploaded were added as favorite; Total number of times that all video responses were added as favorite; Total number of times that all responded videos were added as favorite; Total number of honors of all videos uploaded; Total number of honors of all video responses; Total number of honors of all responded videos; Total number of links of all videos uploaded; Total number of links of all video responses; Total number of links of all responded videos; Average number of views of all videos uploaded; Average number of views of all video responses; Average number of views of all responded videos; Average duration of all videos uploaded; Average duration of all video responses; Average duration of all responded videos; Average number of ratings of all videos uploaded; Average number of ratings of all video responses; Average number of ratings of all responded videos; Average number of comments of all videos uploaded; Average number of comments of all video responses; Average number of comments of all responded videos; Average number of times that all videos uploaded were added as favorite; Average number of times that all video responses were added as favorite; Average number of times that all responded videos were added as favorite; Average number of honors of all videos uploaded; Average number of honors of all video responses; Average number of honors of all responded videos; Average number of links of all videos uploaded; Average number of links of all video responses; and Average number of links of all responded videos).

The set of attributes from 43 to 50 capture social relationships established between users that interact using video response (Clustering Coefficient; Reciprocity; UserRank—same as PageRank; Betweenness; Assortativity: in-in degree; Assortativity: in-out degree; Assortativity: out-in degree; and Assortativity: out-out degree).

Finally, attributes from 50 to 60 are related to individual characteristics of user behavior (Number of responses posted; Number of responses received; Number of friends; Number of videos watched; Number of videos uploaded; Number of videos added as favorite; Number of subscriptions; Number of subscribers; Maximum number of videos uploaded in 24 hours; and Average time between video uploads).

The algorithm learns a classification model from a set of previously labeled (i.e., pre-classified) data, and then applies the acquired knowledge to classify new (unseen) users into three classes: legitimate, spammers and promoters. Note that, in this invention, it is not address the labeling process. Labeled data may be obtained through various initiatives (for example, volunteers who help marking video spam, professionals hired to periodically manually classify a sample of users, etc). The goal here is to assess the potential effectiveness of the proposed approach as a first effort towards helping system administrators to detect polluters in online video social networks.

To assess the effectiveness of classification strategies the standard information retrieval metrics of recall were used, precision, Micro-F1, and Macro-F1 (as described by Y. Yang in An evaluation of statistical approaches to text categorization; Information Retrival, 1, 1999). The recall (r) of a class X is the ratio of the number of users correctly classified to the number of users in class X. Precision (p) of a class X is the ratio of the number of users classified correctly to the total predicted as users of class X. In order to explain these metrics, we will make use of a confusion matrix, illustrated in Table 2. Each position in this matrix (as described by R. Kohavi and F. Provost in Glossary of terms; Special Issue on Applications of Machine Learning and the Knowledge Discovery Process, Machine Learning, 30, 1998) represents the number of elements in each original class, and how they were predicted by the classification. In Table 2, the precision (pₚᵣₒₘ) and the recall (rₚᵣₒₘ) of the class promoter are computed as pₚᵣₒₘ=a/(a+d+g) and rₚᵣₒₘ=a/(a+b+c).

TABLE 2
Example Confusion Matrix

| | Predicted | Predicted | Predicted |
|---|---|---|---|
| | Promoter | Spammer | Legitimate |
| True promoter | a | b | c |
| True Spammer | d | e | f |
| True Legitimate | g | h | i |

The F1 metric is the harmonic mean between both precision and recall, and is defined as F1=2pr/(p+r). Two variations of F1, namely, micro and macro, are normally reported to evaluate classification effectiveness. Micro-F1 is calculated by first computing global precision and recall values for all classes, and then calculating F1. Micro-F1 considers equally important the classification of each user, independently of its class, and basically measures the capability of the classifier to predict the correct class on a per-user basis. In contrast, Macro-F1 values are computed by first calculating F1 values for each class in isolation, as exemplified above for promoters, and then averaging over all classes. Macro-F1 considers equally important the effectiveness in each class, independently of the relative size of the class. Thus, the two metrics provide complementary assessments of the classification effectiveness. Macro-F1 is especially important when the class distribution is very skewed, as in this case, to verify the capability of the classifier to perform well in the smaller classes.

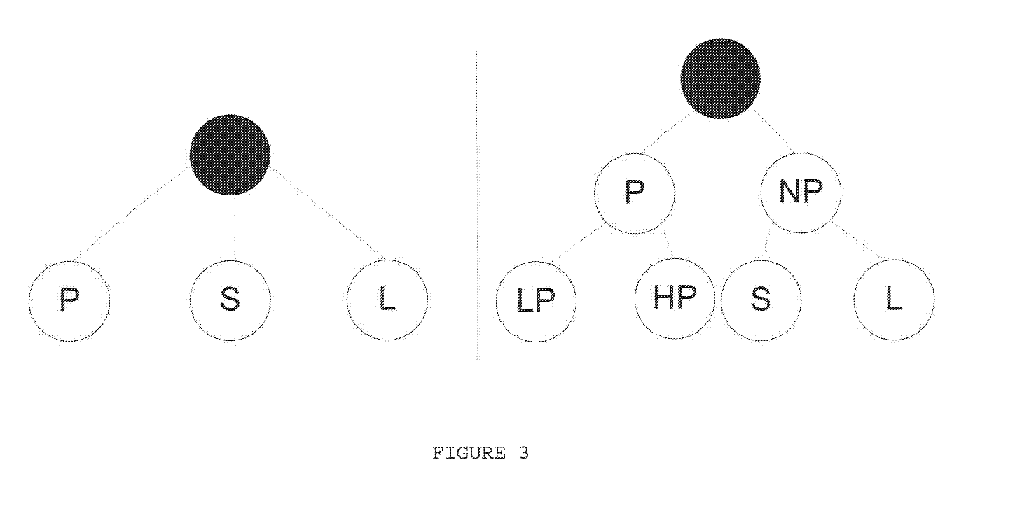

The classification algorithm, i.e., the classifier, and the experimental setup used are presented below. The classifier was applied according to two different strategies, referred to as flat and hierarchical classifications. In the flat classification, illustrated in FIG. 3 (left), the users from the test collection are directly classified into promoters (P), spammers (S), and legitimate users (L). In the hierarchical strategy, the classifier is first used to separate promoters (P) from non-promoters (NP). Next, it classifies promoters into heavy (HP) and light promoters (LP), as well as non-promoters into legitimate users (L) and spammers (S), in a hierarchical fashion shown in FIG. 3 (right).

A Support Vector Machine (SVM) classifier (as described by T. Joachims in Text categorization with support vector machines: Learning with many relevant features, In European Conference on Machine Learning (ECML), 1998) was used which is a state-of-the-art method in classification and obtained the best results among a set of classifiers tested. The goal of a SVM is to find the hyperplane that optimally separates with a maximum margin the training data into two portions of an N-dimensional space. A SVM performs classification by mapping input vectors into an N dimensional space, and checking in which side of the defined hyperplane the point lies. SVMs are originally designed for binary classification but can be extended to multiple classes using several strategies (for example one against all as described by C.-W. Hsu and C.-J. Lin in A comparison of methods for multiclass support vector machines, IEEE Transactions on Neural Networks, volume 13, 2002). A non-linear SVM was used with the Radial Basis Function (RBF) kernel to allow SVM models to perform separations with very complex boundaries. The implementation of SVM used in the experiments is provided with libSVM (as described by R. Fan, P. Chen, and C. Lin in Working set selection using the second order information for training SVM, Journal of Machine Learning Research (JMLR), 6, 2005) an open source SVM package that allows searching for the best classifier parameters using the training data, a mandatory step in the classifier setup. In particular, the easy tool from libSVM was used which provides a series of optimizations, including normalization of all numerical attributes. For experiments involving the SVM J parameter it is used a different implementation called SVM light since libSVM does not provide this parameter. The classification results are equal for both implementations when it is used the same classifier parameters.

The classification experiments are performed using a 5-fold crossvalidation. In each test, the original sample is partitioned into 5 sub-samples, out of which four are used as training data, and the remaining one is used for testing the classifier. The process is then repeated 5 times, with each of the 5 sub-samples used exactly once as the test data, thus producing 5 results. The entire 5-fold cross validation was repeated 5 times with different seeds used to shuffle the original data set, thus producing 25 different results for each test. The results reported are averages of the 25 runs. With 95% of confidence, results do not differ from the average in more than 5%.

Below, are presented the results obtained with the two classification strategies (flat and hierarchical) using all 60 selected attributes, since even attributes with low ranks according to the employed feature selection methods (for example, UserRank) may have some discriminatory power, and may be useful to classify users. Moreover, SVMs are known for dealing well with high dimensional spaces, properly choosing the weights for each attribute, i.e., attributes that are not helpful for classification are given low weights by the optimization method used by the SVM as described by T. Joachims in Text categorization with support vector machines: Learning with many relevant features, in European Conference on Machine Learning (ECML), 1998.

### Flat Classification

Table 3 shows the confusion matrix obtained as the result of the experiments with the flat classification strategy. The numbers presented are percentages relative to the total number of users in each class. The diagonal in boldface indicates the recall in each class. Approximately 96% of promoters, 57% of spammers, and 95% of legitimate users were correctly classified. Moreover, no promoter was classified as legitimate user, whereas only a small fraction of promoters were erroneously classified as spammers (3.87%). By manually inspecting these promoters, we found that the videos that they targeted (i.e., the promoted videos) actually acquired a certain popularity. In that case, it is harder to distinguish them from spammers, who target more often very popular videos, as well as from some legitimate users who, following their interests or social relationships, post responses to popular videos. Referring to FIG. 2(a), these (somewhat successful) promoters are those located in the higher end of the curve, where the three user classes cannot be easily distinguished.

TABLE 3
Flat Classification

| | Predicted | Predicted | Predicted |
|---|---|---|---|
| | Promoter | Spammer | Legitimate |
| True promoter | 96.13% | 3.87% | 0.00% |
| True Spammer | 1.40% | 56.69% | 41.91% |
| True Legitimate | 0.31% | 5.02% | 94.66% |

A significant fraction (almost 42%) of spammers was misclassified as legitimate users. In general, these spammers exhibit a dual behavior, sharing a reasonable number of legitimate videos (non-spam) and posting legitimate video responses, thus presenting themselves as legitimate users most of the time, but occasionally posting video spams. This dual behavior masks some important aspects used by the classifier to differentiate spammers from legitimate users. This is further aggravated by the fact that a significant number of legitimate users post their video responses to popular responded videos, a typical behavior of spammers. Therefore, as opposed to promoters, which can be effectively separated from the other classes, distinguishing spammers from legitimate users is much harder. As a summary of the classification results, Micro-F1 value is 87.5, whereas per-class F1 values are 63.7, 90.8, and 92.3, for spammers, promoters, and legitimate users, respectively, resulting in an average Macro-F1 equal to 82.2. The Micro-F1 result indicates that we are predicting the correct class in almost 88% of the cases. Complementarily, the Macro-F1 result shows that there is a certain degree of imbalance for F1 across classes, with more difficulty for classifying spammers. Comparing with a trivial baseline classifier that chooses to classify every single user as legitimate, we obtain gains of about 13% in terms of Micro-F1, and of 183% in terms of Macro-F1. As a first approach, the proposed classification provides significant benefits, being effective in identifying polluters in the system.

Therefore, in summary, in the method of distinguish spammers and promoters from legitimate users using flat classification each user is represented by vector containing all the attributes. Thus, in order to distinguish users, the users are classified directly in one of the three classes: spammers, promoters or legitimate users. A detailed description of the mechanism is described next.

1) Model Creation:

a) Input: a training set consisting on a set of users labeled as spammers, promoters, and legitimate users represented by an attribute vector.

b) A statistical classification algorithm receives the training set and produces a model that maps combinations of attribute values to the three classes of users: spammers, promoters, and legitimate users.

2) Detection

a) Input: the model created in step 1 and a set of users and their attribute vectors.

b) A statistical classification algorithm uses the model and the attribute vector of the users to classify the users as spammers, promoters, or legitimate users.

### Hierarchical Classification

The flat classification results show that promoters might be effectively identified, but separating spammers from legitimate users is a harder task. The experiment with a hierarchical classification strategy, illustrated in FIG. 3 (right) allows the advantage of a cost mechanism in the SVM classifier, specific for binary classification. In this mechanism, one can give priority to one class (for example, spammers) over the other (for example, legitimate users) by varying its J parameter (as described by K. Morik, P. Brockhausen, and T. Joachims in Combining statistical learning with a knowledge-based approach—a case study in intensive care monitoring, In Int'l Conference on Machine Learning (ICML), 1999) The J parameter is the cost factor by which training errors in one class outweigh errors in the other. It is useful when there is a large imbalance between the two classes, to counterbalance the bias towards the larger one.

By varying J, several tradeoffs and scenarios can be studied. In particular, it is evaluated the tradeoffs between identifying more spammers at the cost of misclassifying more legitimate users, and we further categorize promoters into heavy and light, based on their aggressiveness. Splitting the set of promoters is also motivated by the potential for disparate behaviors with different impact on the system, thus requiring different treatments. On one hand, heavy promoters may reach top lists very quickly, requiring a fast detection. On the other hand, light promoters may conceal a collusion attack to promote the same responded video, thus requiring further investigation.

TABLE 4
Hierarchical Classification of Promoters vs. Non-Promoters

| | Predicted | Predicted |
|---|---|---|
| | Promoter | Non-Promoter |
| True Promoter | 92.26% | 7.74% |
| True Non-promoter | 0.55% | 99.45% |

The results for the first phase of the hierarchical classification (promoters versus non-promoters) are summarized in Table 4. Macro-F1 and Micro-F1 are 93.44 and 99.17, respectively. Similarly to the results with the flat characterization, the vast majority of promoters were correctly classified (both results are statistically indistinguishable). In fact, the absolute number of erroneously classified users in each run of a test is very small (mostly 1 or 0).

As previously discussed, there are cases of spammers and legitimate users acting similarly, making the task of differentiating them very difficult. In this section, we perform a binary classification of all (test) users identified as non-promoters in the first phase of the hierarchical classification, separating them into spammers and legitimate users. For this experiment, the classifier was trained with the original training data without promoters.

TABLE 5
Hierarchical Classification of Non-Promoters

| | Predicted | Predicted |
|---|---|---|
| | Legitimate | Spammer |
| True Legitimate | 95.09% | 4.91% |
| True Spammer | 41.27% | 58.73% |

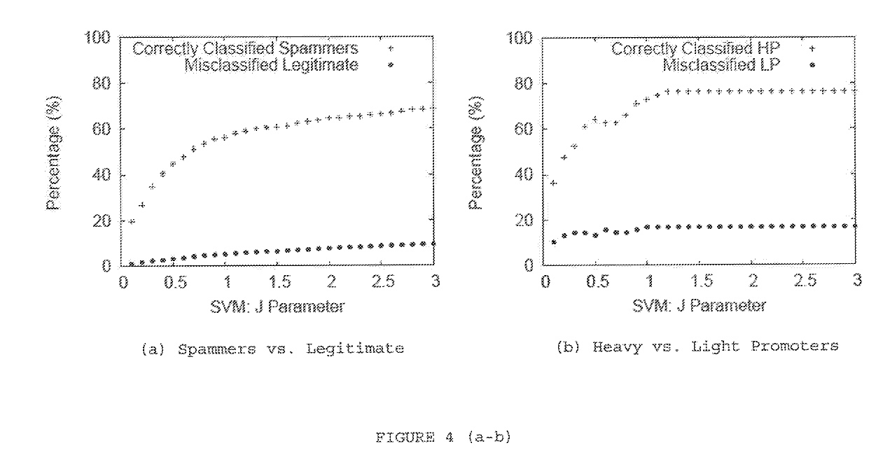

Table 5 shows results of this binary classification. In comparison with the flat classification (Table 3), there was no significant improvement on separating legitimate users and spammers. These results were obtained with J=1. FIG. 4(a) shows that increasing J leads to a higher percentage of correctly classified spammers (with diminishing returns for J>1.5), but at the cost of a larger fraction of misclassified legitimate users. For instance, one can choose to correctly classify around 24% of spammers, misclassifying only 1% legitimate users (J=0.1). On the other hand, one can correctly classify as much as 71% of spammers (J=3), paying the cost of misclassifying 9% of legitimate users. The best solution to this tradeoff depends on the system administrator's objectives. For example, the system administrator might be interested in sending an automatic warning message to all users classified as spammers, in which case they might prefer to act conservatively, avoiding sending the message to legitimate users, at the cost of reducing the number of correctly predicted spammers. In another situation, the system administrator may prefer to detect a higher fraction of spammers for manual inspection. In that case, misclassifying a few more legitimate users has no great consequence, and may be preferred, since they will be cleared out during inspection. It should be stressed that we are evaluating the potential benefits of varying J. In a practical situation, the optimal value should be discovered in the training data with cross-validation, and selected according to the system administrator goal.

In order to be able to further classify promoters into heavy and light, we need first a metric to capture the promoter “aggressiveness”, and then each promoter is labeled as either heavy or light, according to this metric. The metric chosen to capture the aggressiveness of a promoter is the maximum number of video responses posted in a 24-hour period. It is expected that heavy promoters would post a large number of videos in sequence in a short period of time, whereas light promoters, perhaps acting jointly in a collusion attack, may try to make the promotion process imperceptible to the system by posting videos at a much slower rate. The k-means clustering algorithm (as described by A. Jain, M. Murty and P. Flynn in Data clustering: a review. ACM Computing, Surveys, 31, 1999) was used to separate promoters into two clusters, labeled heavy and light, according to this metric. Out of the 31 promoters, 18 were labeled as light, and 13 as heavy. As expected, these two groups of users exhibit different behaviors, with different consequences from the system perspective. Light promoters are characterized by an average “aggressiveness” of at most 15.78 video responses posted in 24 hours, with coefficient of variation (CV) equal to 0.63. Heavy promoters, on the other hand, exhibit an average behavior of posting as much as 107.54 video responses in 24 hours (CV=0.61). In particular, after manual inspection, we found that all heavy promoters posted a number of video responses sufficient to boost the ranking of their targets to the top 100 most responded videos of the day (during collection period). Some of them even reached the top 100 most responded videos of the week, of the month and of all time. On the other hand, no light promoter posted enough video responses to promote the target to the top lists (during the collection). However, all of them participated in some collusion attack, with different subsets of them targeting different videos.

A binary classification of all (test) users identified as promoters in the first phase of the hierarchical classification was performed, separating them into light and heavy promoters. To that end, the classifier was retrained with the original training data containing only promoters, each one labeled according to the cluster it belongs to. The results are summarized in Table 6. Approximately 83% of light promoters and 73% of heavy promoters are correctly classified. FIG. 4 (right) shows the impact of varying the J parameter, and how a system administrator can trade detecting more heavy promoters (HP) for misclassifying a larger fraction of light promoters (LP). A conservative system administrator may choose to correctly classify 36% of heavy promoters at the cost of misclassifying only 10% of light promoters (J=0.1). A more aggressive one may choose to classify as much as 76% of heavy promoters, if he can afford misclassifying 17% of the light ones (J≧1.2).

TABLE 6
Hierarchical Classification of Promoters

| | Predicted Light | Predicted |
|---|---|---|
| | Promoter | Heavy Promoter |
| True Light Promoter | 83.33% | 16.67% |
| True Heavy Promoter | 27.12% | 72.88% |

It is noticed an interesting finding with respect to collusion of promoters (especially light promoters). Intuitively, if one identifies one element of collusion, the rest of the collusion can be also detected by analyzing other users who post responses to the promoted video. By inspecting the video responses posted to some of the target videos of the detected promoters, it is found hundreds of new promoters among the investigated users, indicating that the approach can also effectively unveil collusion attacks, guiding system administrator towards promoters that are more difficult to detect.

Once it is understood the main tradeoffs and challenges in classifying users into spammers, promoters and legitimate, it is possible to turn to investigate whether competitive effectiveness can be reached with fewer attributes. It is reported results for the flat classification strategy, considering two scenarios.

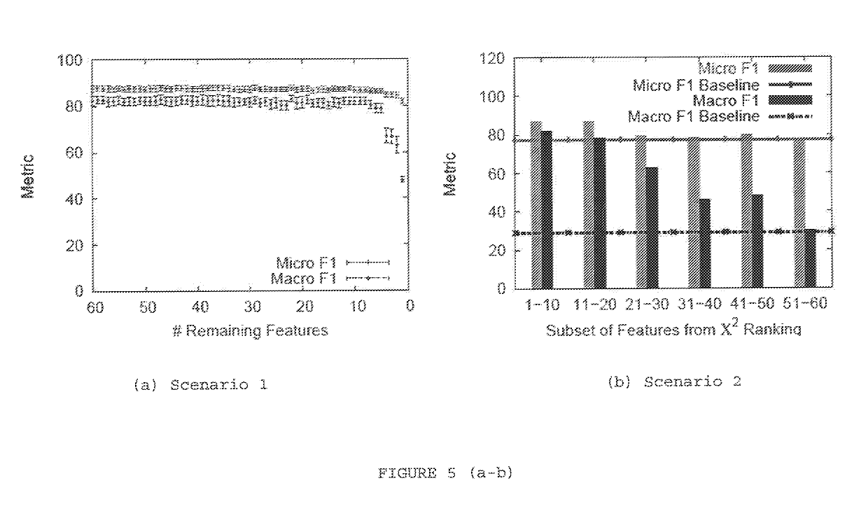

Scenario 1 consists of evaluating the impact on the classification effectiveness of gradually removing attributes in a decreasing order of position in the X² ranking. FIG. 5(a) shows Micro-F1 and Macro-F1 values, with corresponding 95% confidence intervals. There is no noticeable (statistical) impact on the classification effectiveness (both metrics) when as many as the 40 lowest ranked attributes are removed. It is worth noting that some of the most expensive attributes such as UserRank and betweenness, which require processing the entire video response user graph, are among these attributes. In fact, all social network attributes are among them, since UserRank, the best positioned of these attributes, is in the 30^{th} position. Thus, the classification approach is still effective even with a smaller, less expensive set of attributes. The Figure also shows that the effectiveness drops sharply when some of the top 10 attributes from the process are removed.

Scenario 2 consists of evaluating the classification when subsets of 10 attributes occupying contiguous positions in the ranking (i.e., the first top 10 attributes, the next 10 attributes, etc) are used. FIG. 5(b) shows Micro-F1 and Macro-F1 values for the flat classification and for the baseline classifier that considers all users as legitimate, for each such range. In terms of Micro-F1, the classification provides gains over the baseline for the first two subsets of attributes, whereas significant gains in Macro-F1 are obtained for all attribute ranges, but the last one (the 10 worst attributes). This confirms the results of the attribute analysis that shows that even low-ranked attributes have some discriminatory power. In practical terms, significant improvements over the baseline are possible even if not all attributes considered in the experiments can be obtained.

Promoters and Spammers can pollute video retrieval features of online video social networks, compromising not only user satisfaction with the system, but also system resources and aspects such as caching. It is proposed an effective solution to the problem of detecting these polluters that can guide system administrators to spammers and promoters in online video social networks. Relying on a sample of pre-classified users and on a set of user behavior attributes, the flat classification approach was able to detect correctly 96% of the promoters, 57% of spammers, wrongly classifying only 5% of the legitimate users. Thus, the proposed approach poses a promising alternative to simply considering all users as legitimate or to randomly selecting users for manual inspection. It is also investigated a hierarchical version of the proposed approach, which explores different classification tradeoffs and provides more flexibility for the application of different actions to the detected polluters. As example, the system administrators may send warning messages for the suspects or put the suspects in quarantine for further investigation. In the first case, the system administrators could be more tolerant to misclassifications than in the second case, using the different classification tradeoffs that were proposed. Finally, it is found that the classification can produce significant benefits even if only a small subset of less expensive attributes is available.

It is expected that spammers and promoters will evolve and adapt to anti-pollution strategies (i.e. using fake accounts to forge some attributes as described by F. Douglis in On social networking and communication paradigms, IEEE Internet Computing, 12, 2008). Consequently, some attributes may become less important whereas others may acquire importance with time. Thus, labeled data needs also to be constantly updated and the classification models need to be re-learned. Periodical assessment of the classification process may be necessary in the future so that retraining mechanisms could be applied. It is also natural to expect that the approach could benefit from other anti-pollution strategies. It is chosen three to discuss herein. (1) User Filtering: If most owners of responded videos check their video responses to remove those which are polluted videos, video spamming would be significantly reduced. The challenge here is to provide users incentives that encourage them to filter out polluted video responses. (2) IP Blocking: Once a polluter is detected, it is natural to suspend his account. Additionally, blocking IP addresses to respond or to upload new videos (but not to watch content) could be useful to prevent polluters from continuing acting maliciously on the system with new accounts. (3) User Reputation: Reputation systems allow users to rank each other and, ideally, users engaging in malicious behavior eventually would develop low reputations (as described by S. Kamvar, M. Schlosser, and H. Garcia-Molina in The eigentrust algorithm for reputation management in p2p networks, In Int'l World Wide Web Conference j(WWW), 2003). However, current designs of reputation systems may suffer from problems of low robustness against collusion, and high implementation complexity.

In terms of refinements for the proposed approach to detect spammers and promoters, the results shows that the method used can benefit from the use of semi-supervised learning methods to reduce the need for large amounts of the labeled data. It is also explored the combination of multiple classifiers through ensembles or exploration of multiple views based on different attribute sets (for example, based on video, user, and social network attributes). Finally, better classification effectiveness have been obtained by exploring additional features such as temporal aspects of the user behavior and also features obtained from other social networks derived from YouTube user interactions.

Therefore, in summary, in the second approach, called “hierarchical classification”, users are first classified as promoters or non-promoters. Then, users classified as promoters are sub-classified as heavy promoters or light promoters. Users classified as non-promoters are then sub-classified as spammers or legitimates.

1) Model Creation

a) Input: a training set consisting on a set of users labeled as promoters and non-promoters. Non-promoters are also labeled as spammers and legitimate users and promoters are labeled as heavy-promoters and light-promoters.

b) Based on the training set, a statistical classification algorithm three models. The first model, namely model 1, maps users into two classes of users: promoters and non-promoters. The second (model 2), maps promoters into heavy and light. The third model (model 3) maps non-promoters into spammers and legitimate users.

2) Detection

a) Input: the three models created in step 1 and a set of users and their attribute vectors.

b) A statistical classification algorithm firstly uses the attribute vector of the users and model 1 to distinguish promoters from non-promoters.

c) Then, model 2 is used to distinguish the users classified as promoters into twp sub-classes: heavy promoters and light promoters. Similarly, model 3 is used to further classify non-promoters into spammers or legitimate users.

1. Method for classifying an user in a video social networks comprising the steps of:
generating a set of video social networks users, each user having a set of user behavior attributes;
creating a statistical model to distinguish different users classes based on user behavior attributes; and
classifying each user using the statistical model.

2. Method as defined in claim 1, wherein the step of creating a statistical model comprises the steps of:
generating a training set of users, each user having a set of user behavior attributes;
labeling the training set of users based on the user's classes;
selecting user behavior attributes to investigate their relative discriminatory power to distinguish one user class from the others;
determining the discriminatory power using feature selection methods; and
ordering the selected attributes in an attribute ranking based on their discriminatory power.

3. Method as defined in claim 2, wherein the step of creating a statistical model further comprises the steps of:
mapping combinations of the attributes to the different user classes using an algorithm; and
performing a comparative analysis of the mapping results and the attributes of the training set of users in order to adjust the algorithm.

4. Method as defined in claim 2, wherein the step of labeling the training set of users comprises the step of categorizing the users as spammers, promoters or legitimate users.

5. Method as defined in claim 2, wherein the step of labeling the training set of users comprises the step of categorizing the users as promoters and non-promoters.

6. Method as defined in claim 5, wherein the step of labeling the training set of users comprises the step of categorizing the non-promoters users as spammers or legitimate users.

7. Method as defined in claim 5, wherein the step of labeling the training set of users comprises the step of categorizing the promoters users as heavy-promoters and light-promoters.

8. Method as defined in claim 1, wherein the step of classifying each user using the statistical model includes the step of varying a parameter in order to give priority to one class.

9. Method as defined in claim 2, wherein the feature selection methods are the information gain and X² (Chi Squared).

10. Method as defined in claim 3, wherein the algorithm is a SVM algorithm.

11. Method as defined in claim 1, wherein the user behavior attributes are related to properties of the videos uploaded by each user, the social relationship established between users that interact using video response and the individual characteristics of the user behavior.

12. Method as defined in claim 11, wherein the attributes related to properties of the videos uploaded by each user comprises information regarding the total number of views of all video responses; total number of views of all responded videos; total duration of all videos uploaded; total duration of all video responses; total duration of all responded videos; total number of ratings of all videos uploaded; total number of ratings of all video responses; total number of ratings of all responded videos; total number of comments of all videos uploaded; total number of comments of all video responses; total number of comments of all responded videos; total number of times that all videos uploaded were added as favorite; total number of times that all video responses were added as favorite; total number of times that all responded videos were added as favorite; total number of honors of all videos uploaded; total number of honors of all video responses; total number of honors of all responded videos; total number of links of all videos uploaded; total number of links of all video responses; total number of links of all responded videos; average number of views of all videos uploaded; average number of views of all video responses; average number of views of all responded videos; average duration of all videos uploaded; average duration of all video responses; average duration of all responded videos; average number of ratings of all videos uploaded; average number of ratings of all video responses; average number of ratings of all responded videos; average number of comments of all videos uploaded; average number of comments of all video responses; average number of comments of all responded videos; average number of times that all videos uploaded were added as favorite; average number of times that all video responses were added as favorite; average number of times that all responded videos were added as favorite; average number of honors of all videos uploaded; average number of honors of all video responses; average number of honors of all responded videos; average number of links of all videos uploaded; average number of links of all video responses; or average number of links of all responded videos.

13. Method as defined in claim 11, wherein the attributes related to properties related to the social relationship established between users that interact using video response comprises information regarding clustering coefficient; reciprocity; UserRank—same as PageRank; betweenness; assortativity: in-in degree; assortativity: in-out degree; assortativity: out-in degree; or assortativity: out-out degree.

14. Method as defined in claim 11, wherein the attributes related to properties related to the individual characteristics of the user behavior comprises information regarding number of responses posted; number of responses received; number of friends; number of videos watched; number of videos uploaded; number of videos added as favorite; number of subscriptions; number of subscribers; maximum number of videos uploaded in 24 hours; or average time between video uploads.
